(19) United States
(12) Patent Application Publication
(10) Pub. No.: US 2017/0069045 A1
(43) Pub. Date: Mar. 9, 2017

(54) METHOD AND SYSTEM FOR AUTOMATICALLY NOTIFYING A CONCERNED PARTY CORRESPONDING TO A CASE

(71) Applicant: Modern Law, LLC, Kennesaw, GA (US)

(72) Inventors: Adam Michael Slipakoff, Kennesaw, GA (US); John Hawkins, Kennesaw, GA (US)

(21) Appl. No.: 15/257,342

(22) Filed: Sep. 6, 2016

Related U.S. Application Data
(60) Provisional application No. 62/213,903, filed on Sep. 3, 2015.

(51) Int. Cl. G06Q 50/18; G06Q 10/10; H04L 12/58

(52) U.S. Cl. CPC G06Q 50/18; H04L 51/18; G06Q 10/1095

(57) ABSTRACT

A system for automatically notifying at least one concerned party corresponding to a case is disclosed. The system includes a database configured to store records of multiple cases associated with, for example, a legal proceeding. The multiple cases may be associated with multiple events for the legal proceeding. A schedule corresponding each case may comprise at least one of the following: a case identifier associated with the case, a location, a date and a time. Further, the system may comprise a processor communicatively coupled to the database. The processor may be configured to generate a notification corresponding to the case and the schedule associated with the case. Moreover, the system includes a communication module coupled to the processor. The communication module may be configured to communicate the notification to one or more electronic devices associated with the one or more concerned parties.

### RELATED APPLICATIONS

Under provisions of 35 U.S.C. §119(e), the Applicant claims the benefit of U.S. provisional application No. 62/213,903, filed Sep. 3, 2015, which is incorporated herein by reference.

Related U.S. patent application Ser. No. ______, [TO BE UPDATED POST-EXAMINATION], filed on even date herewith in the name of Modern Law and entitled “METHOD AND SYSTEM FOR AUTOMATICALLY NOTIFYING A CONCERNED PARTY CORRESPONDING TO A CASE,” having Attorney Docket No. 481E.P001US02, is hereby incorporated by reference in its entirety.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure relates generally to information systems and more specifically to a method and system for providing event notifications.

### BACKGROUND

Court cases generally involve a lot of communication between the concerned parties such as the judge, the attorneys, paralegal staff, plaintiff(s), and defendant(s). Currently, the communication from court to legal professional(s) are exchanged through a plurality of channels, including printed or hand-typed documents known as notices and sent from the court to the attorney of record via a mail service, a public notice advertisement in the local publication either via printed document, website, and sometimes on the court clerk's website. The processes for such communications are defined by local jurisdictions and vary vastly from one location to another across the United States.

It is ultimately the practitioner's responsibility to know when to appear in court as set by a judge. Failing to appear in court may result in a procedural error that is fatal to a party's position in the legal matter as well as disciplinary action up to and including revocation of the legal professional's ability to practice law. Therefore, members of the legal profession place great emphasis and importance on calendaring their court appearances.

However, the complexity and multiple sources and various communication channels used to manage a legal professional's calendar for court appearances are time consuming. Further, it is a cumbersome task, and therefore a management problem. The legal system is vast, and the various systems are rarely interconnected. In addition, a judge's calendar can change at any time. The legal professionals must be aware of each court's process to communicate a calendar notice and verify the correct information.

Accordingly, there remains a need for a system of automatically notifying the legal professionals of impending court dates such that the errors are reduced.

### BRIEF OVERVIEW

The present disclosure satisfies the above-described and other needs by providing methods and systems (collectively referred to as a ‘platform’) for automatically notifying and/or scheduling at least one concerned party corresponding to a case. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The platform may comprise, or be in operative communication with, a database configured to store records of multiple cases presented to a legal institution. The multiple cases may be associated with multiple schedules. A schedule corresponding to a case may comprise, for example, but not be limited to, a case identifier associated with the case, a date, and a time when the case is heard by the legal institution. In yet further embodiments, and as will be detailed below, case details may be stored and retrieved from the platform.

Furthermore, the platform may comprise a processor communicatively coupled to the database. The processor may be configured to generate a notification corresponding to a case. Moreover, the platform may comprise a communication module coupled to the processor. The communication module may be configured to communicate the notification to one or more electronic devices associated with the one or more concerned parties.

According to some embodiments, a platform for automatically notifying the legal professional from a server system to a client system may be provided. A user of the platform may be, for example, but not limited to, an interested party to a case, a legal representative or a delegated employee such as a paralegal. The user may receive a notification associated with a case at a client system from the server via their preferred channel of contact, and may then be able to add the event details to their calendar. The notification may be, for example, but not limited to, a software application, an SMS, an MMS, and/or an email. The notification may comprise, for example, a calendar event configured to be populated in the user's digital calendar. The calendar event may correspond to, but not be limited to, a location, a date and time associated with the case. In some embodiments, the calendar event may be automatically displayed on the user's calendar, without requiring the user to read or accept the notification. In this way, the notification communicated to the user can be simultaneously registered on the user's calendar.

Still consistent with embodiments of the present disclosure, the notification may further comprise information associated with the case. Such information may be associated with case data including, but not limited to, opposing attorney(s), name(s) of plaintiff(s), defendant(s), location of the courthouse, and case history.

The platform may further enable the user to send a response back to the server, indicating that the invitation was accepted and added to their calendar, allowing the platform to track which notices have been accepted. This information may then be available for the user to review a status of a plurality of cases and the associated calendar event which may be included in a notification. In some embodiments, the platform may indicate which notifications were read or remain unread. If, during the course of reviewing these, an individual in the process of reviewing the accepted invitations sees one that has not been accepted, the notice may be sent out again to the user. Thus, the platform may be enabled to resend notices to each platform user upon certain triggers (e.g., a manual trigger, a passing of a period of time without the notification being read or accepted, and other triggers that may be specified by a user).

Conventional systems, obtaining information about scheduled court hearings and proceedings required the user to actively seek such information from newspapers, periodicals, and other legal organs. According to some embodiments, a platform for electronically delivering automated notifications containing information about certain court hearings and proceedings to a user is provided. The platform may consistently retrieve and/or receives updates associated with cases and push each updated to platform users. Such data may be stored and updated regularly in a database associated with the platform. The data may include, but not be limited to, names of all individuals and parties that may have an interest in the case. Methods and systems for retrieving the updates are disclosed in greater detail below.

Embodiments of the present disclosure may provide a platform that enables an enrolled to receive automated notifications containing information about certain court hearings and proceedings. The user may enroll to the platform and receive notifications on a client system. In some embodiments, users may enroll by purchasing licenses to various court jurisdictions. When the user is enrolled in the platform (e.g., a user's name/email), the platform may be configured to access the databases to determine which cases the user may be associated with. Upon determining that the user is associated with the cases, the system may begin to push notifications associated with each case to the user. In this way, with doing little more than enrolling in the platform's notification system, the probability that the user will miss an updated court event (e.g., action or ruling) or a court hearing or proceeding is greatly decreased.

Thus, one objective of the embodiments disclosed herein may be to decrease the likelihood that the user will miss a court hearing or proceeding to which the user is counsel of record, a party, or otherwise involved by electronically delivering automated notifications of such a hearing or proceeding directly to the user. The process seeks to reduce the time and effort legal professionals and litigants expend researching such court related information by providing a method and system for organizing human activity.

Another objective of the embodiments disclosure herein may be to keep an interested party in a case (e.g., a plaintiff or a defendant) up-to-date on the developments in the case. Even though the interested party may have legal representation in the case, the legal representation may not provide the interested party with case developments as quickly as the interested party would like to receive the case updates. By enabling the interested party to enroll in the platform to receive notifications, they may no longer need to rely on timely updates from their legal counsel and, in turn, their legal counsel may no longer need to provide timely updates to their client.

Still consistent with embodiments, the legal counsel enrolled in the platform notifications may be enabled to extend the notifications to their client by enrolling their client to receive the notifications as well. In such embodiments, the legal counsel may be provided with an option to have the notifications sent to their client from a platform branded to their institution or on behalf of their email address. According to some embodiments, a system for an online platform that requests and obtains updates from data sources in order to provide an event notification service to those in the legal community. According to some further embodiments, processes for data retrieval, storage, analysis, and notification are stored in an Internet-accessible computing environment. A user may access a portal, or website, to access the information and apply modifications to their preferences, including the number of sources to which they will subscribe, how many and which names for the system to notify them, how often and the method via which they prefer to be notified. Clients may be independent attorneys, attorneys at a law firm, general counsel for a company or corporation, or the general public. The systems and methods of the present disclosure, therefore provide clients with real-time or near real-time updates to event notifications from a court system, by means of the Internet via any communications device in any well-known or emerging form, such as a computer, mobile phone, tablet, watch, electronic wearables, or the like.

According to some embodiments, a method of collecting data from court input resources, including web scraping and direct connections via, for example, application programming interfaces (APIs), and other channels of communications; a database residing on a server to which the data may be stored; a scheduling engine for timing of input events; a scheduling engine for timing of calendar notification events; a scheduling engine for mapping of input data to correct fields; a database repository for court calendar event data to be stored; a database repository for archived court calendar event data to be stored; a method of notifying the user of upcoming court calendar event data and receiving confirmation or rejection of receipt of notifications.

According to some embodiments, a method for notifying, reissuing notification, or forwarding notification of subscriber data upon the detection of new court calendar events is provided. The method includes automatically notifying the user of new court data; automatically notifying the user of failure to respond to notifications after a configurable time period; allowing the user to forward events (or configure the platform to cause the forwarding) to additional recipients via email or other communication means.

According to some embodiments, a system for notifying a plurality of users is provided. The system wherein one user may act for multiple notifications via any of common interface access methods, such as web pages, mobile applications, and the like; a server wherein the stored data for multiple subscribed attorneys may be monitored by a single individual, such as a paralegal.

According to some embodiments, a system for notifying a subscriber of updates on specific changes in a database is provided. The updates may include, for example, a specific court case having a date added. The system includes a server wherein the user may receive notification via email or any other communication method when events are added to the court calendar for that case. Further, a process to automatically poll the database to see if there are additions or changes to the specified fields in the database is also provided. Such updates may be then provided as notifications to platform users.

According to some embodiments, a system for notifying a subscriber of the event of a lawsuit is provided. The system includes a server wherein the user may configure to receive notification via email or any other communication method when a certain event is added to the database in events such as, for example, when a lawsuit is placed against a certain recipient or a plurality of recipients. Further, a process to automatically poll the database to see if there are additions or changes to the specified fields in the database is also provided. Such updates may be then provided as notifications to platform users.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure.

FIG. 2 is a block diagram of a system for automatically notifying a concerned party corresponding to a legal case, in accordance with an embodiment.

FIG. 3 is a functional block diagram for accessing the system, in accordance with an embodiment.

FIG. 4 illustrates a database format according to a sample embodiment.

FIG. 5 illustrates a functional block diagram setting forth the general stages involved in automatically notifying a concerned party corresponding to a case according to a sample embodiment.

FIG. 6 illustrates a flowchart for a method for automatically notifying a concerned party corresponding to a case in accordance with a sample embodiment.

FIG. 7 illustrates a flowchart for a method for registering new users in accordance with an embodiment.

FIG. 8 illustrates a flowchart for a method for performing customization in accordance with an embodiment

FIG. 9 illustrates a flowchart for a method for assigning subscribed licenses in accordance with a sample embodiment.

FIG. 10 illustrates a flowchart for a method for a trial user sub-process in accordance with a sample embodiment.

FIG. 11 illustrates a flowchart for a method for a paid user sub-process in accordance with a sample embodiment.

FIG. 12 illustrates a flowchart for a method for a notification generation process in accordance with a sample embodiment.

FIG. 13 illustrates a sample web interface display for user sign-up in accordance with a sample embodiment.

FIG. 14 illustrates a sample web interface display for adding and searching for lawyers' webpage in accordance with a sample embodiment.

FIG. 15 illustrates a sample web interface display for managing team in accordance with a sample embodiment.

FIG. 16 illustrates a sample web interface display for a dashboard in accordance with a sample embodiment.

FIG. 17 illustrates a sample web interface display for a calendar in accordance with a sample embodiment.

FIG. 18 illustrates a sample web interface display for a calendar in accordance with a sample embodiment.

FIG. 19 illustrates a sample web interface display for license management webpage in accordance with a sample embodiment.

FIG. 20 illustrates a sample web interface display for license management webpage in accordance with a sample embodiment.

FIG. 21 is a block diagram of a system including a computing device for performing the various embodiments disclosure herein.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and sample of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

I. Platform Overview

The present disclosure includes many aspects and features. Moreover, while many aspects and features relate to, and are described in, the context of provisioning ingredients corresponding to court notifications, embodiments of the present disclosure are not limited to use only in this context. For example, the platform may be configured in a like manner to provide user notifications associated with other institutions.

Consistent with embodiments of the present disclosure, a method and system (hereinafter referred to a ‘platform’) for automatically notifying a concerned party corresponding to a legal case may be provided. For instant, embodiments of the present disclosure may provide a court-date tracking system. The tracking system may monitor the dockets associated with various court systems and notify interested parties of upcoming events associated with each docketed case. The platform may email the attorney notifications, case data, calendar invitations, and/or reminders associated with the events. In this way, the attorney may receive near instantaneous updates associated with a legal case.

Accordingly, the platform may facilitate automatic notifications for a concerned party corresponding to a legal case. Although embodiments of the present disclosure are described with reference to a legal case having court calendar events, the present disclosure may be applicable to other events associated with different institutions. The platform may be configured to request and obtain updates from data sources in order to provide an event notification service to the concerned party. Further, the platform may be configured for notifying, reissuing notification, or forwarding notification of subscriber data upon the detection of new court calendar events associated with a case.

The platform may be accessed by one or more entities such attorneys, clients and paralegals (hereinafter referred to as a ‘platform user’ or a ‘concerned party’). Further, the platform may facilitate interaction amongst the one or more entities. For example, the platform may provide a software application that the one or more entities may install on their respective computing devices. For example, the software application may be a smartphone application. The platform may include a website, which includes various user interfaces in operative communication with a backend database having court data for various jurisdictions.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

II. Platform Configuration

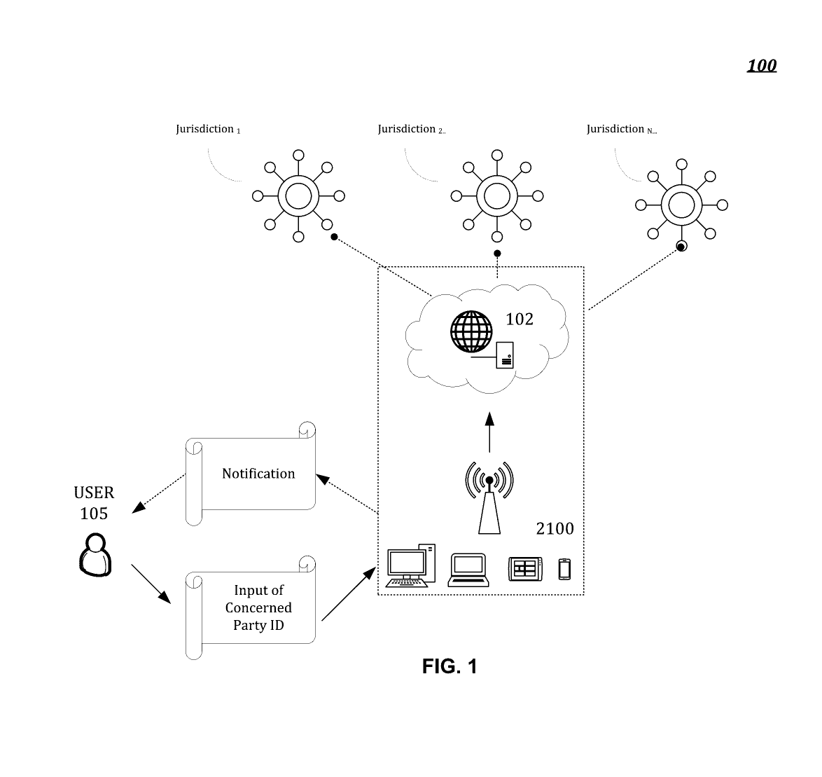

FIG. 1 illustrates one possible operating environment through which a platform consistent with embodiments of the present disclosure may be provided. By way of non-limiting example, an online platform 100 may be hosted on a centralized server 102, such as, for example, a cloud computing service. A user 105 may access the platform 100 through a software application. Examples of the user 105 may include a concerned party such as, for example, but not limited to one or more of attorneys, paralegals, plaintiffs, defendants, subscribers and administrators. The platform 100 may be further accessible by platform users 105 such as visitors interested in information related to court cases.

Centralized server 102 may access and aggregate data from a plurality of data sources. Centralized server 102 may also be represented by computing device 2100. As will be detailed below, data access and aggregation may be performed by a plurality of methods, including, but not limited to, for example, publication scraping or API access. As shown in FIG. 1, the online platform may be accessed by users operating a computing device connected to the online platform 100 over a communication network. Further, the online platform 100 may automatically send information or notifications related to the aggregated data to the computing device of the user 105.

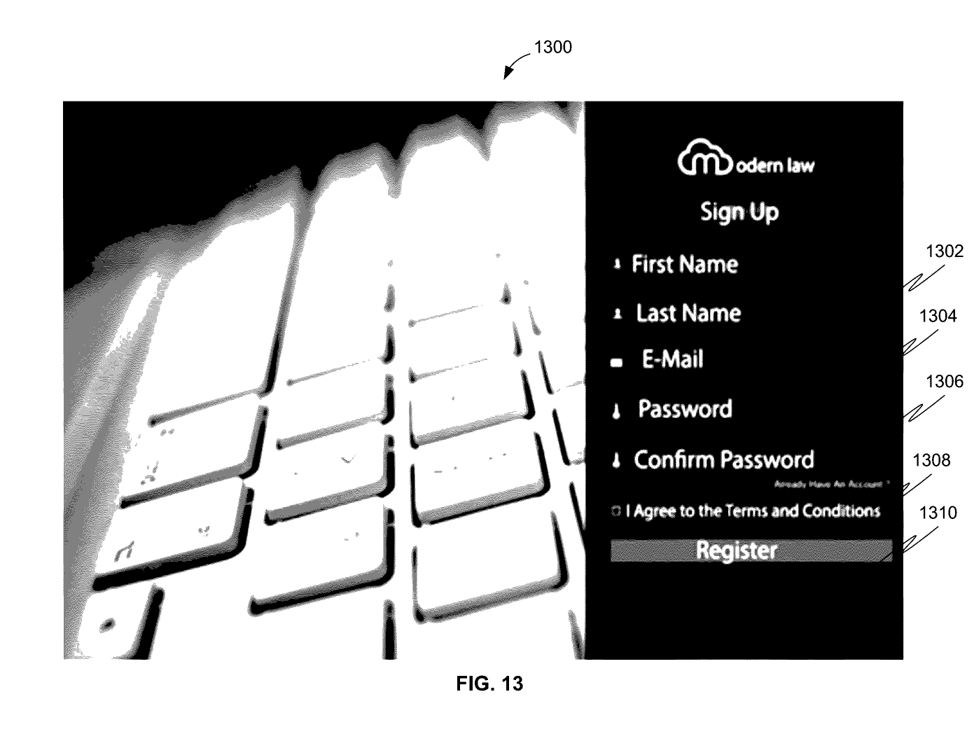

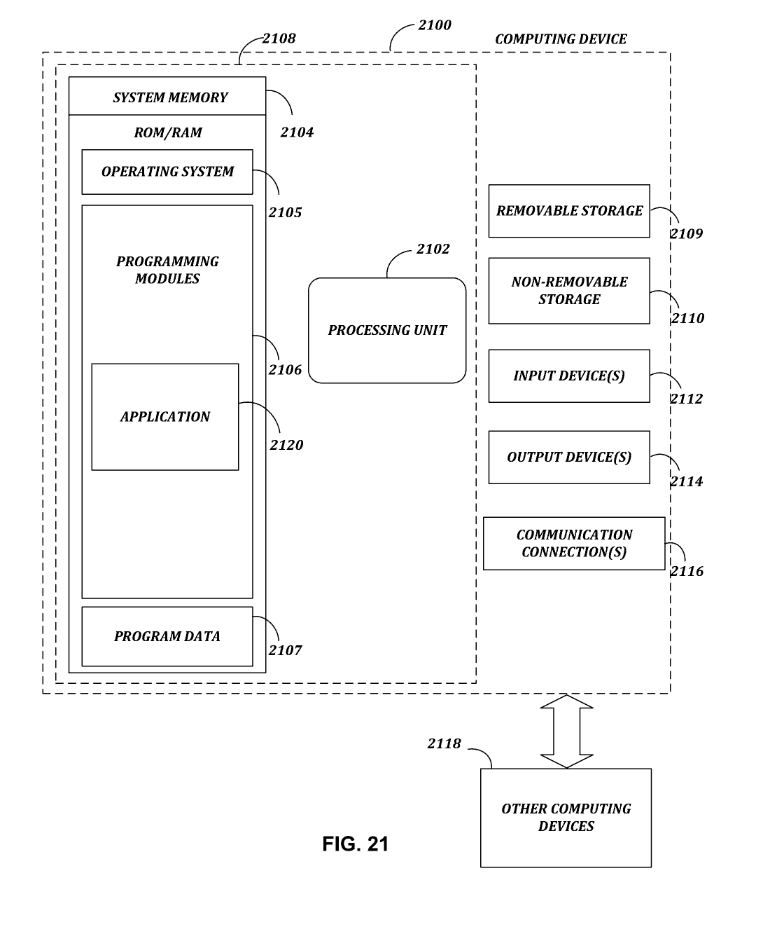

The online platform 100 may present suitable user interfaces according to a type of the platform user. Some sample user interfaces are explained in conjunction with FIGS. 13-20 below. The software application may be embodied as, for example, but not be limited to, a website, a web application, a desktop application, and a mobile application compatible with the computing device of the user 105. Computing device will be detailed with reference to FIG. 21.

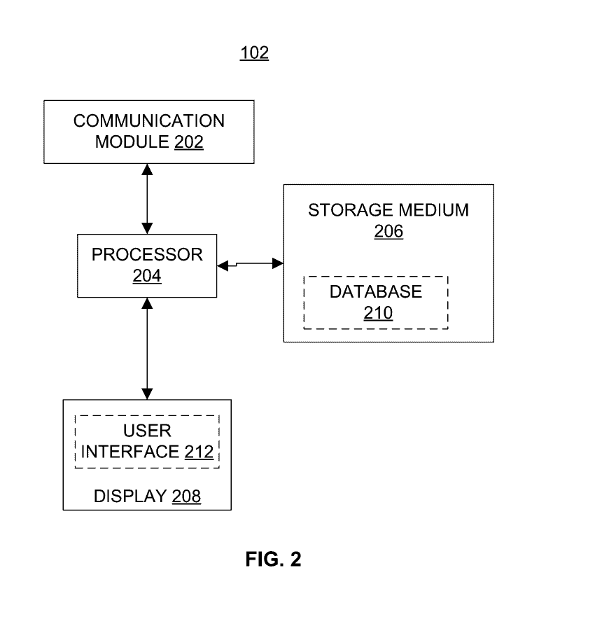

Now, referring to FIG. 2, a system 102 (which may be same as the server 102) for automatically notifying one or more concerned parties corresponding to a case is illustrated in accordance with an embodiment. The system 102 includes a communication module 202, one or more processors (for example, a processor 204), a storage medium (e.g., a memory) 206, and a display 208 (optional).

The storage medium 206 may be a computer readable medium. In some embodiments, storage medium 206 may be a non-transitory computer readable medium, Storage medium 206 may include a database 210 that is configured to access, aggregate, and store records of multiple cases presented to multiple legal institutions. The multiple cases may be associated with multiple schedules. A schedule corresponding to a case may include each of a case identifier associated with the case, a date and a time when the case is heard by the legal institution. The legal institution may be a court or a tribunal. A record corresponding to the case may include an indication of one or more of an attorney and a law firm associated with the case, as well as the parties to the case.

The processor 204 may be communicatively coupled to the database 210 in the storage medium 206. The processor 204 may be configured to generate one or more notifications corresponding to the multiple cases. The one or more notifications may be configured to enter the schedule in a calendar on an electronic device of a concerned party (e.g., user 105). Further, the processor 204 may be configured to generate the one or more notifications prior to the date and the time by a predetermined time duration specified by user 105. For example, the notifications may be generated one day before the due date and time. The processor 204 may be further configured to generate a Graphical User Interface (GUI) configured to enable the user 105 to designate the one or more concerned parties for a particular case.

In this way, user 105, if an attorney representing the case, may assign their paralegal or even their client to receive the notifications associated with the case. Consistent with embodiments of the present disclosure, notifications sent to a client from a lawyer may be branded to a law firm associated with the client. In yet further embodiments, platform 100 may integrate with user 105's email system such that notifications sent to the client come from the representing attorney.

The communication module 202 may be coupled to the processor 204. The communication module 202 may be configured to communicate (via any telecommunications means such as, for example, but not limited to, a SMS, MMS, Email, or other telecommunication) the one or more notifications to one or more electronic devices associated with the platform users 105. The notifications may comprise a calendar event notification that may be accepted or declined by user 105. The calendar event may be in the form of an attachment (e.g., an *.ics attachment) sent along with a message by the communication module 202. The *.ics attachment may include embedded calendar event data such as, but not limited to, for example, a location, an event description, an attachment (e.g., pdf of case data), and reminder settings. Platform user 105 may be enabled to specify default reminder settings for each notification.

The communication module 202 may be further configured to receive at least one of an acceptance and a rejection associated with the one or more notifications from the one or more electronic devices. Further, a calendar on the one or more electronic devices may be updated with the schedule based on the acceptance. In some embodiments, the calendar may be updated even if the user does not accept a calendar invitation associated with the notifications.

The communication module 202 may be further configured to generate a reminder notification based on failure of the one or more concerned parties to send at least one of the acceptance and the rejection within a predetermined time period. The reminder may go out to bother the concerned party and delegates associated with the concerned party (e.g., the attorney's assistant or paralegal). Alternatively, the communication module 202 may deliver the one or more notifications directly to the one or more concerned parties, bypassing the calendar.

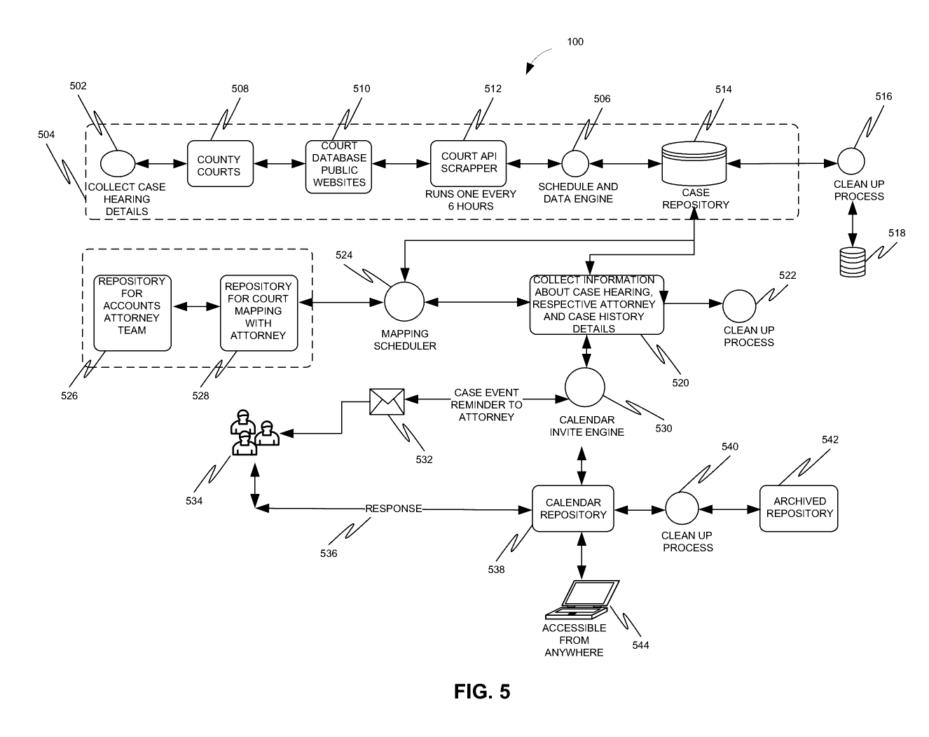

Yet further, the communication module 202 may be configured to communicate with a data source associated with the legal institution. The records of the multiple cases are based on the communication with the data source. The communication with the data source may be based on an API. Alternatively, the communication with the data source comprises web scraping. Moreover, the processor 204 may be configured to map two or more fields in the data source with a corresponding two or more fields in the database 210. The mapping between fields of the data store and the database is explained in further detail in conjunction with FIG. 5 below.

The storage medium 206 may further store instructions that, when executed by the one or more processors 204, cause one or more processors 204 to automatically notify the one or more concerned parties corresponding to the multiple cases in accordance with various embodiments. Further, the storage medium 206 may further store instructions that, when executed by the one or more processors 204, cause one or more processors 204 to execute the methods 500-1200.

The processor 204 may be further configured to detect an event corresponding to the case. The notification includes information associated with the event. The detection of the event includes monitoring for a change in a data source associated with the legal institution, wherein the communication module is further configured to communicate with the data source. The event may be a change in the record associated with the case, wherein each record may include a case history.

Yet further, the processor 204 may be configured to generate a GUI configured to enable the user 105 to provide the indication of one or more of the attorney and the law firm, wherein the processor is further configured to retrieve the record from the database 210 based on the indication and display the record on an electronic device associated with the user based on the retrieval. The GUI may be further configured to enable the one or more concerned parties to provide one or both of the case identifier and an identifier of the legal institution, wherein the retrieval is further based on the one or both of the case identifier and the identifier of the legal institution.

User 105 may enroll themselves and others to the platform and receive notifications on a client system. In some embodiments, users may enroll by purchasing licenses to various court jurisdictions. Once the user 105 is enrolled in the platform (e.g., a user's name/email), the platform may be configured to access the databases to determine which cases the user may be associated with. Upon determining that the user is associated with the cases, the platform may begin to push notifications associated with each case to the user.

Still consistent with embodiments of the present disclosure, user 105 may configure platform 100 to provide notifications to associates and colleagues of user 105. For example, user 105 may be an administrative assistant or a paralegal working with an attorney assigned to the case. User 105 may specify the attorney as a concerned party set to receive notifications for each case to which the attorney is assigned. User 105 may further specify all colleagues working on the case with the attorney to also receive the updated notifications.

The communication module 202 may be used to establish the connectivity to the system 102. The system 102 may interact with the users via a user interface 212 accessible to the users via the display device 208 of any computing device such as laptops, smartphones, computers, tablets, etc.

The user 105 may access the platform 100 using a web browser. Alternatively, the user 105 may install a software application on their computing device to access the platform 100 from the cloud server 102. The software application may be provided by the platform 100. The user 105 may create user profiles on the platform 100. A user profile may include all information for a particular user, such as, but not limited to, login details, location, account balances, historical search data, and demographic information. When required, the user 105 may log into the platform 100 using the login details in their user profile.

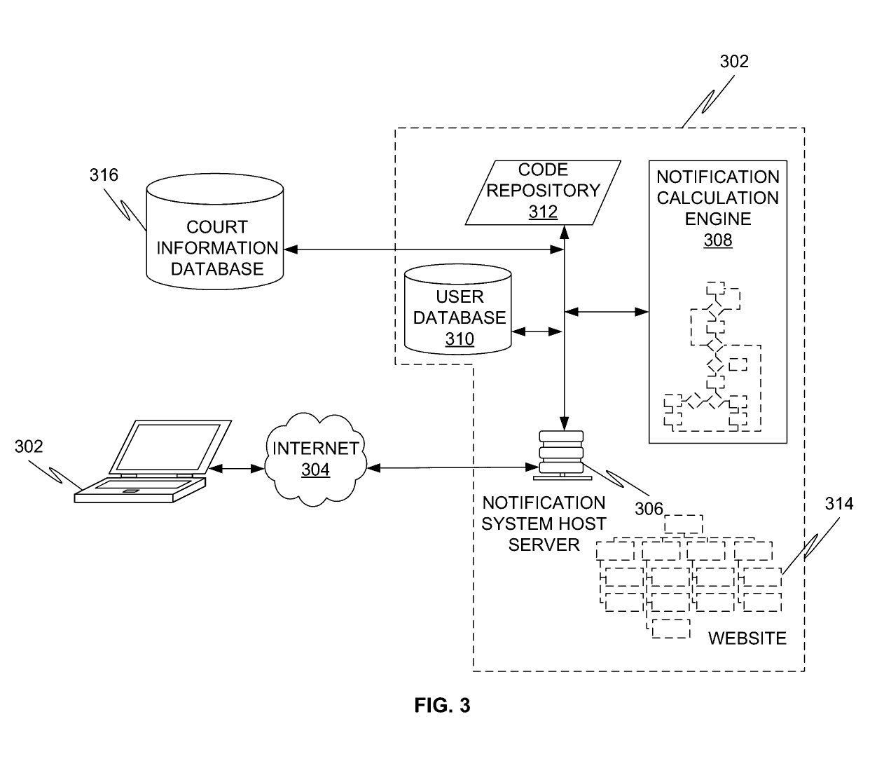

FIG. 3 is a functional block diagram for accessing the system 102, in accordance with a sample embodiment. The user 105 uses a client device 302 to access the system 102 via the Internet 304. The system 102 includes a notification system host server 306, a notification calculation engine 308, a user database 310 and a code repository 312. The user 105 provides login credentials to login to the notification system host server 306. The login credentials are compared with the pre-stored credentials in the user database 310. Once the user successfully signs in, the notification system host server 306 presents appropriate user interfaces to the user 105, such as, via a website 314. The user 105 may then view information provided by the notification system host server 306. The information may be related to one or more cases related to the user 105. The information may be retrieved from a court information database 316. The notification system host server 306 may perform various functions based on programming instructions stored in the code repository 312. The court information database 316 may be located at a remote location from the system 102. The notification calculation engine 308 determines one or more notifications corresponding to the one or more cases related to the user 105. Finally, the notification system host server 306 sends the one or more notifications to the user device 302.

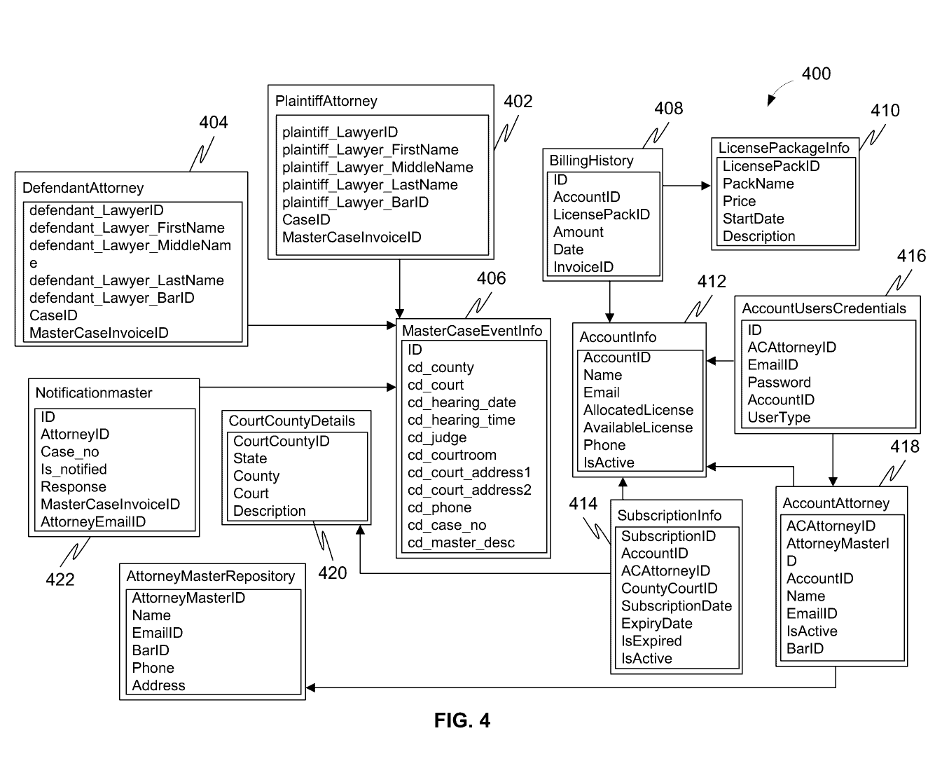

FIG. 4 illustrates a database format 400 of the court information database 316 according to a sample embodiment. The database format 400 shows connections between various database tables. A PlaintiffAttorney database table 402 and a DefendantAttorney database table 404 may be connected to a master-tracking table, named MasterCaseEventInfo table 406. Further, a BillingHistory database table 408, and a LicensePackagelnfo database table 410 may be used for tracking the account balance, history of payment, and number of attorneys and courts or counties to which the user is subscribed. An AccountInfo database table 412 may be used to track the specific account ID, name, e-mail address, number of licensed allocated and available, phone number, and other contact information for each individual user account. A SubscriptionInfo database table 414 may be used to track account expiration information. An AccountUsersCredentials database table 416 may be used for tracking the user account credentials. An AccountAttorneys database table 418 may be used to maintain attorney accounts. A CourtCountyDetails database table 420 may be used for tracking court-specific information. A NotificationMaster database table 422 may be used for tracking user preferences and responses to notifications.

III. Platform Operation

The platform operation is explained via various methods 500-1200 described along with the FIGS. 5-12 below. The various methods 500-1200 may be implemented using a computing device 2100 as described in more detail below with respect to FIG. 21.

Although the methods 500-1200 have been described to be performed by computing device 2100, it should be understood that, in some embodiments, different operations may be performed by different networked elements in operative communication with computing device 2100. For example, the server 102 and/or computing device 2100 may be employed in the performance of some or all of the stages in the methods 500-1200. Moreover, server 102 may be configured much like computing device 2100 and, in some instances, be one and the same embodiment. Similarly, apparatus for automatically notifying one or more concerned parties corresponding to a case may be employed in the performance of some or all of the stages in methods 500-1200. The apparatus may also be configured much like computing device 2100.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein.

FIG. 5 is a functional block diagram setting forth the general stages involved in a method 500 consistent with an embodiment of the disclosure for automatically notifying one or more concerned parties corresponding to a case using the platform 100.

Method 500 may begin at a starting block 502 to initiate a data collection process 504, using the processor 204. The data collection process 504 may be periodically triggered, using the processor 204, by a schedule and data engine 506. For example, the schedule and data engine 506 may trigger the data collection process 504 every 6 hours. Further, the schedule and data engine 506 may provide, using the processor 204, a list of courts for which data needs to be collected.

Thereafter, at stage 508, configuration files corresponding to the courts in the list of courts may be retrieved, using the processor 204. A configuration file corresponding to a court includes information about the process to retrieve data from the respective court. For example, at stage 510, a configuration file corresponding to a particular county court may be accessed. The configuration file may indicate that the court information may be retrieved using a method called web scraping. Web scraping is a computer software technique of extracting information from websites. Therefore, at stage 512, scraping may be performed, using the processor 204, to retrieve information.

In another example, the configuration file may indicate to retrieve data using a direct connection (for example, an API connection) to the servers corresponding to the respective court. The retrieved data may then be stored, using the processor 204, in a case repository 514. The case repository 514 may be similar to the court information database 316. Once data is stored in the case repository 514, a cleaning process may be triggered, using the processor 204, at 516. The cleaning process may remove duplicate data, extraneous characters, and other unrelated data. The clean data may be stored back, using the processor 204, to the case repository 514 at 518. The data collection process 504 may run multiple times to collect information at 520. The cleanup process may be triggered again at 522 to ensure that duplicate data is not saved in the case repository 514.

Thereafter, the stored data may be mapped via a mapping scheduler at 524 to fields in the database 210 that relate to the case, such as the PlaintiffAttorney database table 402, the DefendantAttorney database table 404, the CourtCountyDetails database table 420, and stored in a repository for accounts attorney team 526 and a repository for court mapping with attorney 528. The mapping scheduler at 524 may map the data periodically; for example, every 3 hours.

Thereafter, a calendar invite engine 530 may send a notification 532 to an end user 534. Thereafter, the user 534 may send a response 536 to a calendar repository 538, which then passes it to the cleanup process 540. After a configurable wait period, it may then be stored in the archived repository 542. The data is stored and presented in a manner, which allows the user 534 to access it from any Internet connected device, or device on which they have stored their information 544.

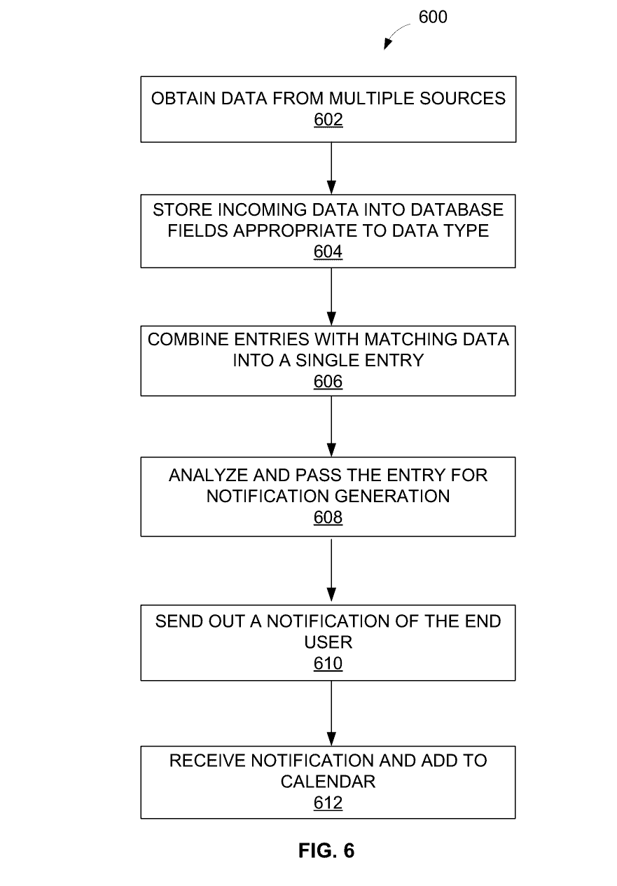

Referring now to FIG. 6, a flowchart for a method 600 for automatically notifying one or more concerned parties corresponding to a case in accordance with an embodiment. At 602, the communication module 202, in conjunction with the processor 204, may obtain data from multiple sources, such as websites of various courts. This is related to the data collection process 504 explained in detail in conjunction with FIG. 5 above. At 604, the processor 204 stores the obtained data into database fields (of the database 210) appropriate to the data type. This is similar to mapping operation performed by a mapping scheduler at 524, as explained earlier in conjunction with FIG. 5 above. Next, at 606, the processor 204 may combine the data with matching key fields such as case number, into a single entry in the database 210. Then, at 608, the processor 204 analyzes the stored data to connect each account's attorneys and courts to their appropriate fields and passes the data for notification generation. The communication module 202 then sends out a notification to the user 105 at 610. At 612, the user 105 receives the notification and adds it to their calendar by clicking “accept” option displayed on a user interface.

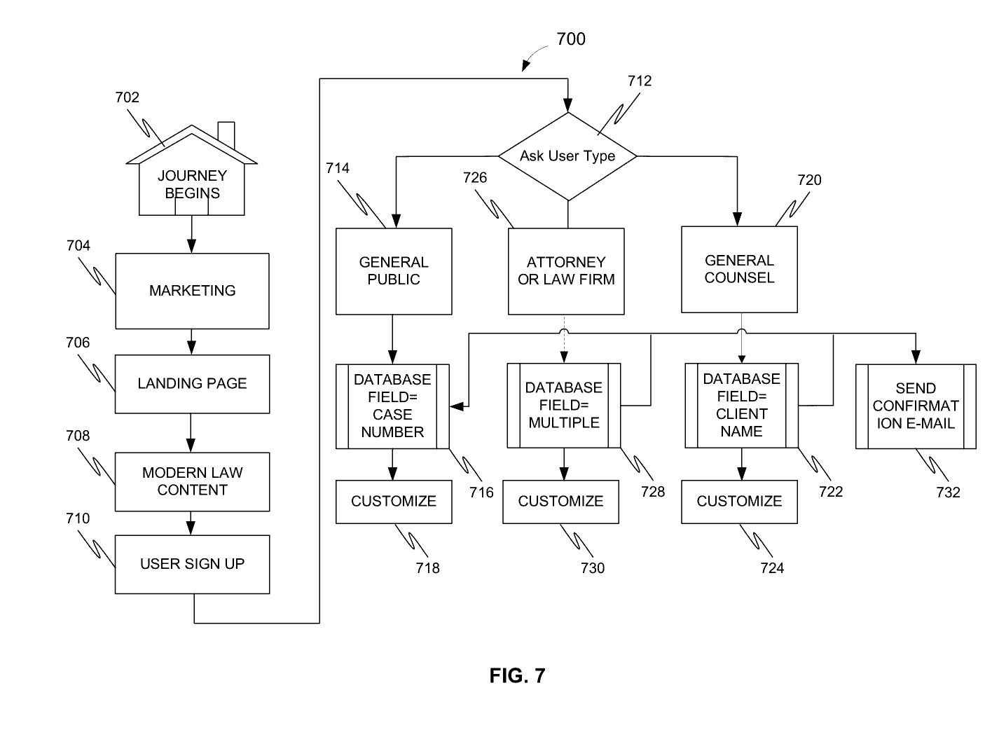

FIG. 7 illustrates a flowchart for a method 700 for registering new users in accordance with an embodiment. At 702, the user 105 (a new user) may be browsing the Internet using a computing device. The user 105 may discover the existence of the platform 100 via a number of means, such as online advertisements and push notifications, exemplified as marketing 704. Then, the user 105 is drawn to a landing page at 706, which then communicates an initial page at 708 to the user 105 via the Internet. The user 105 may then initiate registration at 710. The user may be asked a series of questions during the registration process. A sample registration page is shown in FIG. 13 below. At 712, the method 700 determines a user type. For example, a user registration form may allow the user 105 to select a user type from given options. The options may include general public, attorney or law firm and general counsel.

At 712, if the user 105 selects the option indicating that they are a member of the general public, then they are presented with the option to receive notifications for a single court case at 714, represented by a specific entry in a database field 716. At 718, the user 105 may then proceed to the customize notification settings, where they can select which court case, and how often they should be notified.

At 712, if the user 105 selects the option indicating that they are a General Counsel, then they may be given the option of receiving notifications for a particular client at 720, represented by a specific entry in a database field 722. At 724, the user 105 may then proceed to the customize notification settings, where they can select which client, and how often they are to be notified.

At 712, if the user 105 selects the option indicating that they are an attorney or a law firm, then they may be given the option of receiving notifications for a particular client at 726 represented by a specific entry in a database field 728. At 730, the user 105 may then proceed to the customize notification settings, where they may select which client, and how often they are notified. Finally, at 732, a confirmation email may be sent to the user 105 once the registration process may be complete.

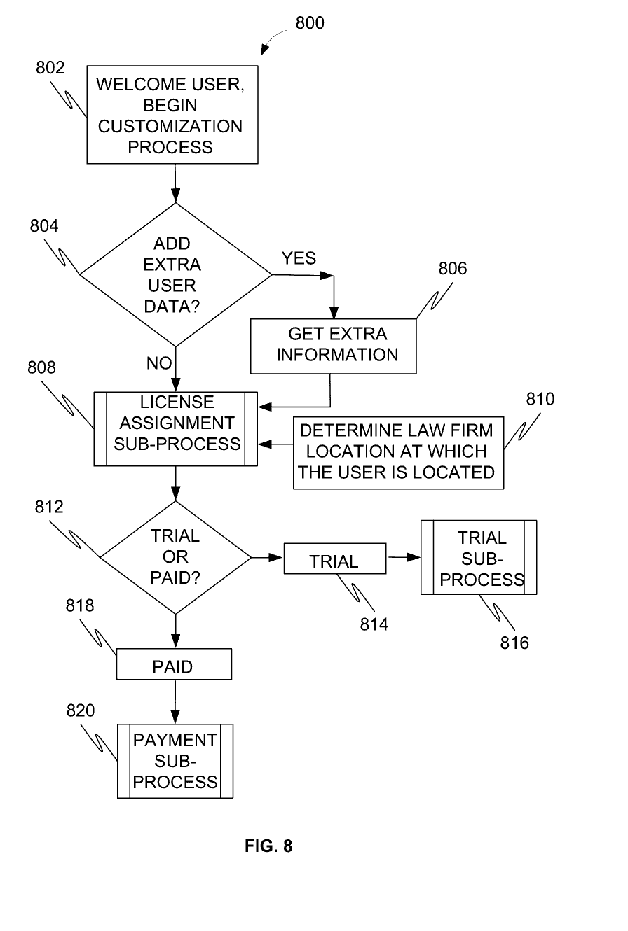

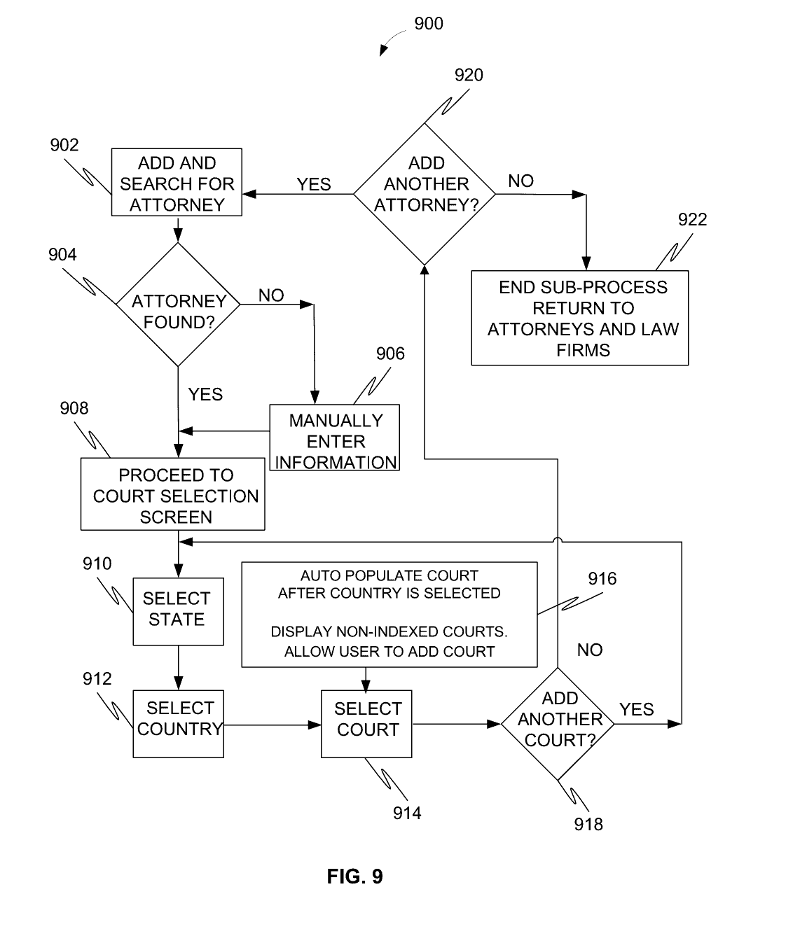

Further, when the user 105 reaches one of customization steps 718, 724 and 730, the user 105 may be presented with more customization options as explained in conjunction with FIG. 8 below. Specifically, FIG. 8 relates to customization method 800 initiated after step 730. As shown, the user 105 may be welcomed to the customization process at 802. Then, at 804, the user 105 is presented with an option to add additional data, such as a more detailed address or additional contact information. If the user 105 selects “Yes” at 804, then they are directed to fill out a form to provide extra information at 806. The, the user 105 fills the form and submits the form, which may be then stored within their account information database table 412. The method 800 then moves the step 808. However, if the user 105 selects “No” at 804, then the method 800 moves directly to 808. The step 808 relates to a license assignment sub-process, which is explained in further detail in conjunction with FIG. 9 below. Further, at 810, a location determination logic may be used to determine the law firm at which the user currently is located.

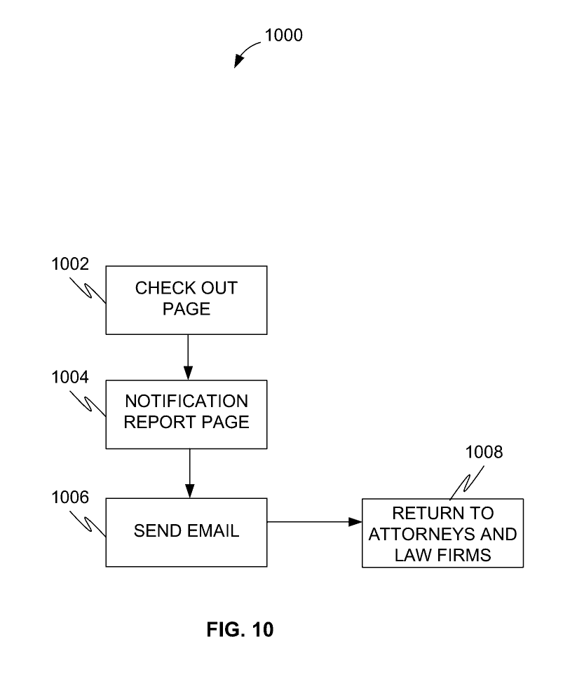

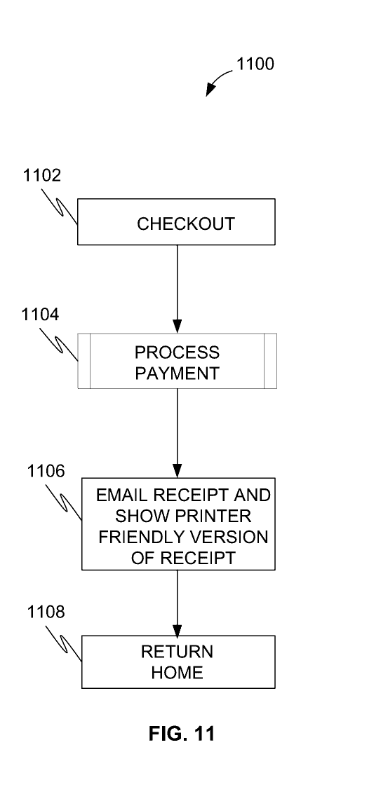

Then, at 812, the user 105 is presented with an option to select a type of account from a trial account and a paid account. If the user 105 selects to start with a trial account, then the method moves to step 814 and then proceed to a trial sub-process at 816. The trial sub-process is explained in further detail in conjunction with FIG. 10 below. However, if the user 105 selects to become a paid member at 812, then the method 800 moves to step 818 and then proceed to a payment sub-process at 820. The payment sub-process is explained in further detail in conjunction with FIG. 11 below.

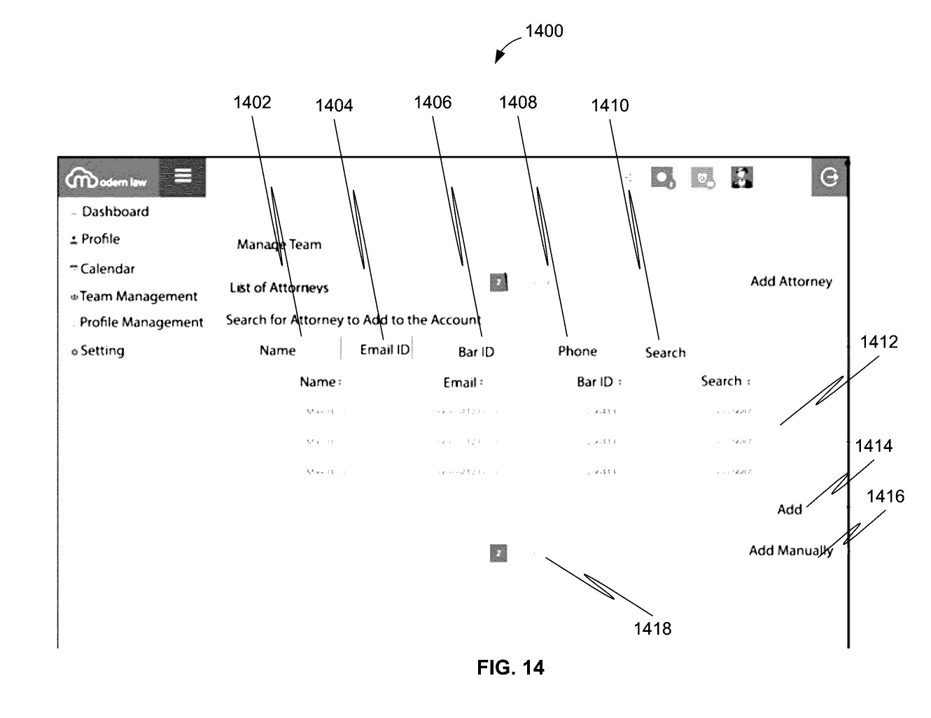

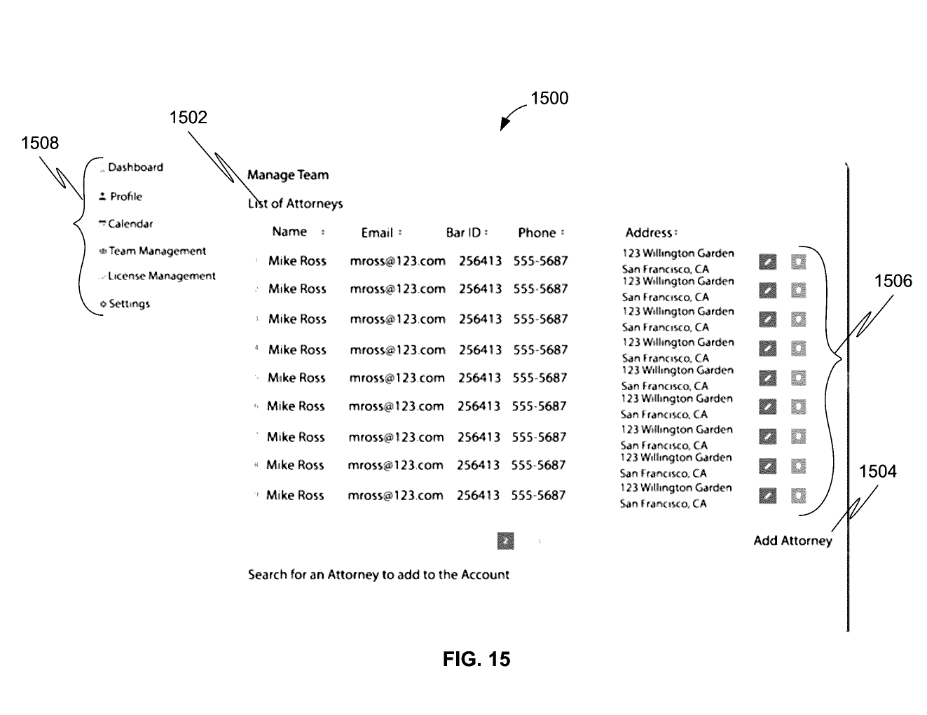

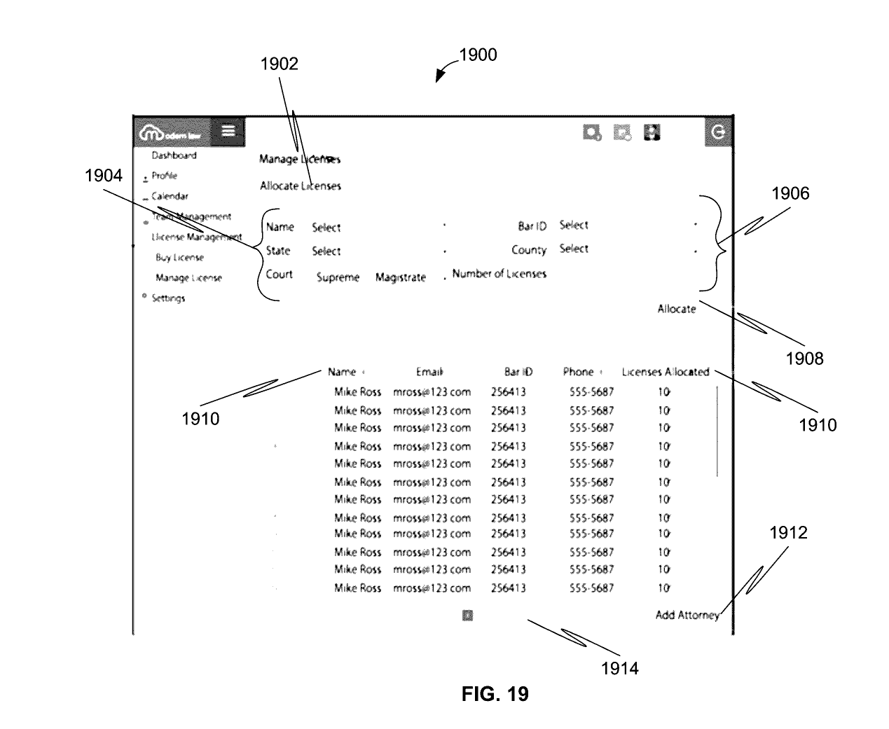

Moving to FIG. 9, which illustrates a flowchart for a method 900 for a license assignment sub-process (from 808 in FIG. 8) for assigning subscribed licenses in accordance with a sample embodiment. At 902, the user 105 is presented with a webpage wherein they may add and search for attorneys in the database 210. The webpage may be a webpage 1900 shown in FIG. 19. Accordingly, the license assignment sub-process is explained in further detail in conjunction with FIG. 19 below. Then, at 904, the processor 204 may match what the user 105 has typed with what is in the database 210. If a match is not found in the database 210, then the method 900 moves to 906, where the user 105 is given the option to manually add the attorney into the database 210. This is explained in further detail in conjunction with FIG. 14 below. However, if the attorney is found at 904, then the user 105 proceeds to a court selection screen at 908. The court selection screen allows the user 105 to selects a state at 910, then a county 912 and a court 914 to which they would like to subscribe. This is explained in further detail in conjunction with FIG. 15 below.

In another embodiment, at 916, the processor 204 may automatically populate field entries with courts which the user may select to add or may have courts listed that are not yet added to the service, to allow users to vote on which ones to add.

Thereafter, the user 105 is presented with an option to add another court at 918. If the user selects “Yes”, then the method 900 goes back to the step 910. However, at 918, if the user 105 selects “No”, then the user 105 is prompted to add another attorney at 920. Further, if the user 105 selects to add another attorney to their account at 920, then the method 900 goes back to step 902. However, at 920, if the user selects “No”, then method 900 ends at 922, and the user 105 is taken back to the home page.

FIG. 10 is a flowchart for a method 1000 for a trial user sub process (from 816 in FIG. 8) in accordance with a sample embodiment. First, at 1002, the user 105 is shown an initial page to checkout. The checkout may require the user 105 to provide credit card details for the record. After the check out, the processor 204 presents a notification report page to the user 105 at 1004. The notification report page may show the notifications that the user 105 is subscribed for. Finally, the communication module 202 sends a confirmation email at 1006 to the user 105. Then at 1008, the method 1000 then returns the user 105 to one of the web pages 1400, 1600, 1700 and 1900.

FIG. 11 is a flowchart for a method 1100 for a paid user sub-process (from 820 in FIG. 8) in accordance with a sample embodiment. First, at 1102, the user 105 is shown an initial page to checkout. After the checkout, the processor 204 directs the user to a sub-page for payment processing at 1104. After payment is completed, the communication module 202 sends an email to the user 105 with details of paid subscription at 1106. Finally, at 1108, the method 1100 then returns the user 105 to one of the web pages 1400, 1600, 1700 and 1900.

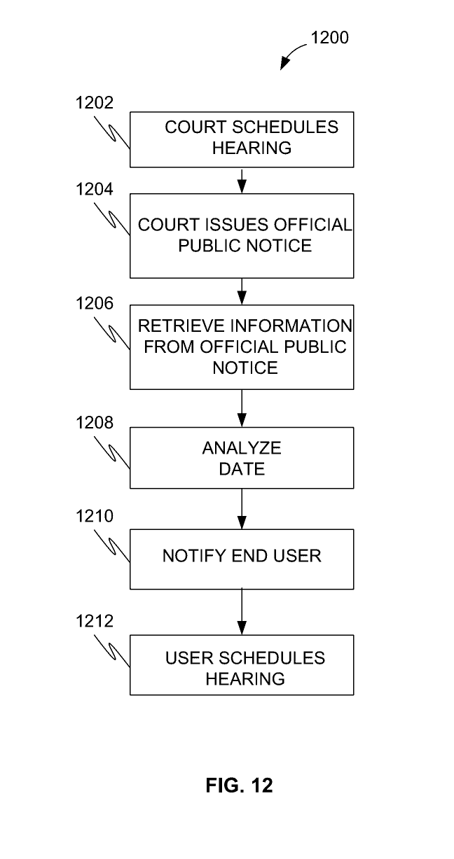

FIG. 12 is a flowchart for a method 1200 for a notification generation process in accordance with a sample embodiment. A court may schedule a hearing at 1202 and issue a public notice at 1204. Then at 1206, the processor 204 in conjunction with the communication module 202 proceeds to pull in that data via a collection method (for example, the data collection process 504). Then, at 1208, the processor 204 analyzes the retrieved data. Thereafter, at 1210, the communication module 202 notifies the end user, who may accept the calendar invitation and add it, or have it automatically added, to their calendar application at 1212, with little-to-no interaction from the end user 105.

FIG. 13 is a user sign-up page 1300 in accordance with a sample embodiment. The page 1300 shows a registration form with various data fields. As shown, the form includes “First Name” and “Last Name” fields 1302, an email address field 1304, and password fields 1306. Additionally, the form may show an “Already Have an Account?” option for a user who already has an account. After entering the required information, the user 105 checkmarks a “Terms and Conditions” field 1308 to agree with the terms and conditions of the platform 100. The Terms and Conditions” field 1308 may be hyperlinked to full text of the terms and conditions of the platform 100. Finally, the user 105 activates a “register” button 1310 to register a new account.

FIG. 14 is an “Add and Search for Lawyers” webpage 1400 in accordance with a sample embodiment. The user 105 may use the webpage 1400 to search lawyers by using one or more of a name field 1402, an email account field 1404, a bar ID field 1406, and a phone number field 1408. Once the fields are filled in, the user 105 may click on a “search” button 1410 to initiate a search. Then, the processor 204 performs a search in the database 210 and displays a list of matching attorneys 1412. The user 105 may then select the preferred result and click an “Add” button 1414. In case, the preferred attorney is not found in the database 210, the user 105 may click an “Add Manually” button 1416 to add the attorney to the database 210 manually. If a large number of search results are obtained, such as from a partial match or common name, additional pages of results are created, which may be selected using “page number” buttons 1418.

FIG. 15 is a “Manage Team” webpage 1500 in accordance with a sample embodiment. The webpage 1500 allows the user 105 to review a list of attorneys 1502, add additional attorneys to monitor to their account using an “Add Attorney” button 1504, remove attorneys from the account or edit the attorney's information and selected monitored courts using buttons 1506. A navigation menu 1508 indicates the current page as “Team Management” page. The navigation menu 1508 allows the user 105 to select a different page by clicking the links in the navigation menu 1508.

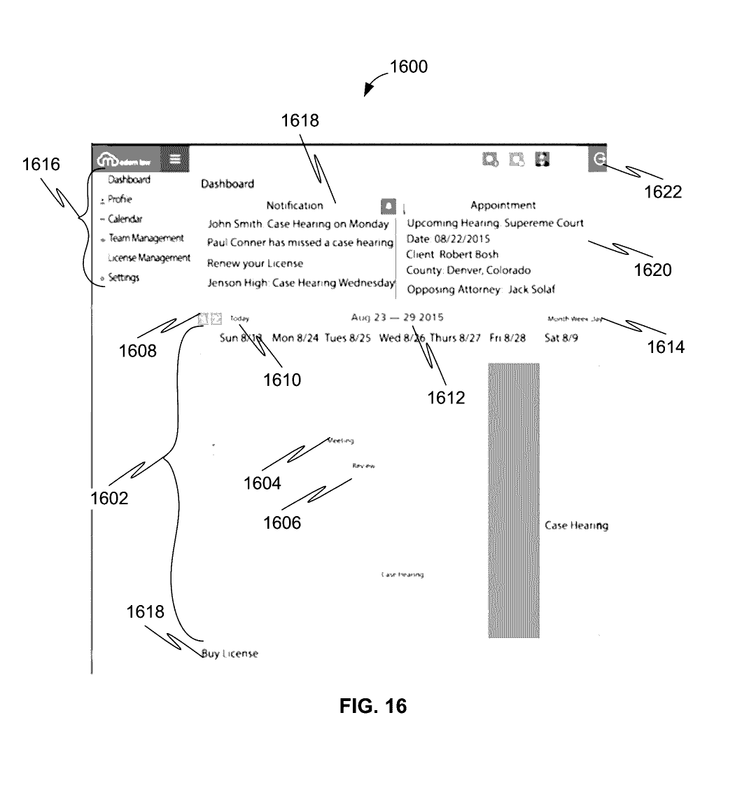

FIG. 16 is a “Dashboard” webpage 1600 in accordance with a sample embodiment. The webpage 1600 provides an overview of currently scheduled events 1602 on a calendar, including events 1604 and 1606. A menu 1608 allows the user 105 to change a current date and an option to return to the current day 1610 marked “Today”. An indicator of the currently selected date range 1612 allows the user 105 to know what date range is being displayed. A menu 1614 allows the user 105 to select from month, week, and day views. A navigation menu 1616 shows the name of the current page by highlighting the corresponding option in the menu 1616. A notifications menu 1618 shows details of recent notifications and the next appointment details 1620. A user menu 1622 shows alerts for upcoming events, licenses, a link to user account information, and an option to sign out.

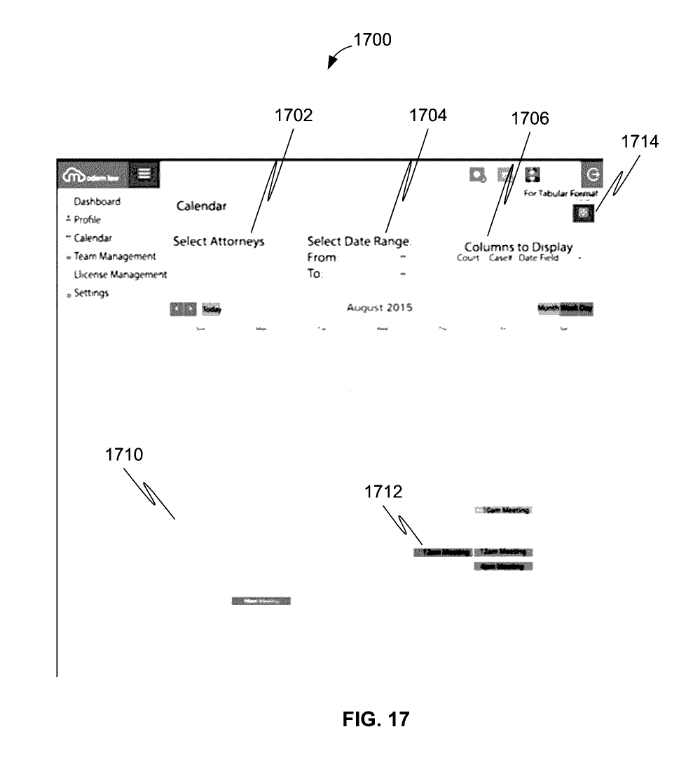

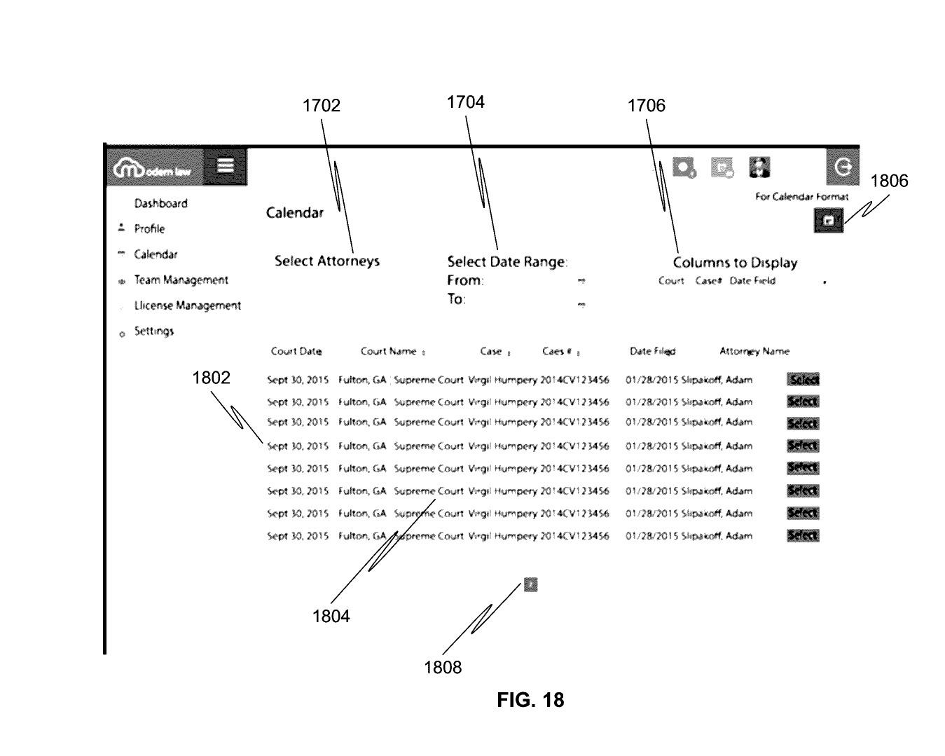

FIG. 17 is a “calendar” webpage 1700 in accordance with a sample embodiment. The user 105 may filter the view of events for attorneys and courts to which they have subscribed. Using a “Select Attorney(s)” drop down 1702, the user 105 may select a single or multiple attorneys. Further, using a “Select Date Range” option 1704 and a “Columns to Display” option 1706, the user 105 may cause the webpage 1700 to display the data as per the user selections of the 1702, 1704 and 1706. The data is displayed in the “calendar view” 1710. Further, an event 1712 may be displayed in the “calendar view” 1710. Additionally, the user 105 may select an alternate tabular view by selecting a “For Tabular Format” option 1714. When the user selects the “For Tabular Format” option 1714, the tabular view 1802 as shown in FIG. 18 is displayed. The tabular view 1802 lists the multiple notifications 1804. The user 105 may again select the “calendar view” 1710 by selecting a “For Calendar Format” option 1806. In the event, the results for the filter exceeds the screens ability to display, additional results will be loaded off of screen, and can be brought into view by selecting from a numerical menu 1808 at the bottom of the search results.

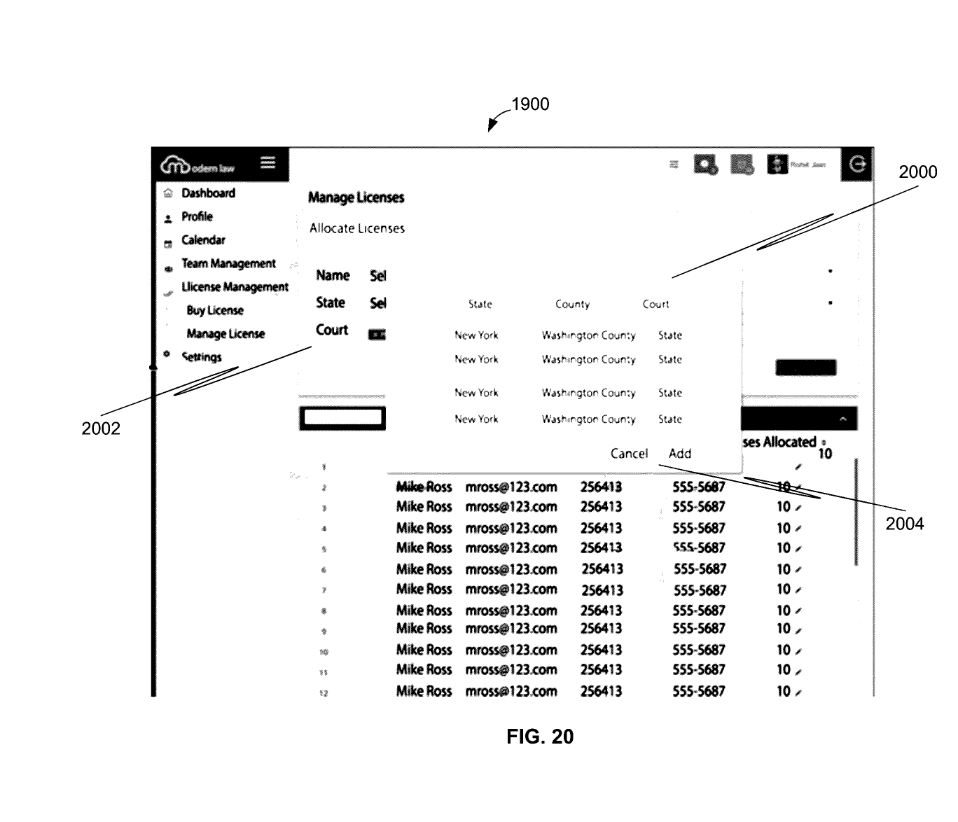

FIG. 19 is a “license management” webpage 1900 in accordance with a sample embodiment. The user 105 may use the webpage 1900 to allocate licenses 1902 to which they have subscribed. Further, the user 105 may view the attorneys whom they have added to their account for purposes of monitoring and receiving notification of court events. The options name, state, and court 1904 and the options bar ID, county, and number of licenses 1906 may be used to add additional courts to a particular lawyer for monitoring and notification. When the appropriate information appears onscreen, the user 105 may click an “Allocate” button 1908 to connect the selected courts with the selects lawyers. The display may include attorney details 1910 such as name, email, bar ID, phone number, and number of licenses allocated. Further, additional attorneys may be added via an “Add Attorney” option 1912. When the user 105 selects appropriate option to allocate additional courts to existing lawyers, a “pop-up” screen 2000 is displayed over the webpage 1900 as shown in FIG. 20. For example, the “pop-up”screen 2000 may appear when the “Court” drop down in 1904 is selected. The “pop-up” screen 2000 allows the user 105 to select the specific courts to which they wish to allocate licenses. The available courts are listed 2002 and the user 105 may select those desired for monitoring and notification, and select “cancel” or “add” options 2004.

IV. Platform Architecture

The online platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the online platform 100 may be hosted on a centralized server, such as, for example, a cloud computing service. Although methods 500-1200 have been described to be performed by computing device 2100, it should be understood that, in some embodiments, different operations may be performed by different networked elements in operative communication with computing device 2100. Moreover, computing device 2100 may perform various other methods described herein.

Embodiments of the present disclosure may comprise a system having a memory storage and a processing unit. The processing unit coupled to the memory storage, wherein the processing unit is configured to perform the stages of methods 500-1200 and the various other methods described herein.

FIG. 21 is a block diagram of a system including computing device 2100. Consistent with an embodiment of the disclosure, the aforementioned memory storage and processing unit may be implemented in a computing device, such as computing device 2100 of FIG. 21. Any suitable combination of hardware, software, or firmware may be used to implement the memory storage and processing unit. For example, the memory storage and processing unit may be implemented with computing device 2100 or any of other computing devices 2118, in combination with computing device 2100. The aforementioned system, device, and processors are examples and other systems, devices, and processors may comprise the aforementioned memory storage and processing unit, consistent with embodiments of the disclosure.

With reference to FIG. 21, a system consistent with an embodiment of the disclosure may include a computing device, such as computing device 2100. In a basic configuration, computing device 2100 may include at least one processing unit 2102 and a system memory 2104. Depending on the configuration and type of computing device, system memory 2104 may comprise, but is not limited to, volatile (e.g. random access memory (RAM)), non-volatile (e.g. read-only memory (ROM)), flash memory, or any combination. System memory 2104 may include operating system 2105, one or more programming modules 2106, and may include a program data 2107. Operating system 2105, for example, may be suitable for controlling computing device 2100's operation. In one embodiment, programming modules 2106 may include GUI modules, search and analytics module and charting modules. Furthermore, embodiments of the disclosure may be practiced in conjunction with a graphics library, other operating systems, or any other application program and is not limited to any particular application or system. This basic configuration is illustrated in FIG. 21 by those components within a dashed line 2108.

Computing device 2100 may have additional features or functionality. For example, computing device 2100 may also include additional data storage devices (removable and/or non-removable) such as, for example, magnetic disks, optical disks, or tape. Such additional storage is illustrated in FIG. 21 by a removable storage 2109 and a non-removable storage 2110. Computer storage media may include volatile and nonvolatile, removable and non-removable media implemented in any method or technology for storage of information, such as computer readable instructions, data structures, program modules, or other data. System memory 2104, removable storage 2109, and non-removable storage 2110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2100. Any such computer storage media may be part of device 2100. Computing device 2100 may also have input device(s) 2112 such as a keyboard, a mouse, a pen, a sound input device, a touch input device, etc. Output device(s) 2114 such as a display, speakers, a printer, etc. may also be included. The aforementioned devices are examples and others may be used.

Computing device 2100 may also contain a communication connection 2116 that may allow device 2100 to communicate with other computing devices 2118, such as over a network in a distributed computing environment, for example, an intranet or the Internet. Communication connection 2116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2104, including operating system 2105. While executing on processing unit 2102, programming modules 2106 (e.g., server application 2120) may perform processes including, for example, one or more of method 200's and 300's stages as described above. The aforementioned process is an example, and processing unit 2102 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and the property of the Applicant. The Applicant retains and reserves all rights in the code included herein, and grants permission to reproduce the material only in connection with reproduction of the granted patent and for no other purpose.

V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system for automatically notifying at least one concerned party corresponding to a case, the system comprising:
a database configured to store records of a plurality of cases, wherein the plurality of cases is associated with a plurality of events, wherein a schedule corresponding to the case is associated with the plurality of events,
a processor communicatively coupled to the database, wherein the processor is configured to generate a notification corresponding to the case, the notification comprising a case identifier, a date, a time, and the schedule associated with the case; and
a communication module coupled to the processor, wherein the communication module is configured to communicate the notification to at least one electronic device associated with the at least one concerned party.

2. The system of claim 1, wherein the processor is further configured to:
receive the name of the at least one concerned party; and
accessing the database to retrieve at least one case associated with the concerned party based on the received name.

3. The system of claim 2, wherein the communication module is instructed to:
provide at least one notification to the at least one concerned party, wherein the at least one notification is associated with the retrieves at least one case.

4. The system of claim 3, wherein the notification further comprises a calendar event associated with the at least one case.

5. The system of claim 1, further comprising at least one client device enabled to receive the notification and associate the notification with a calendar event for the at least one concerned party, the calendar event being based on the schedule associated with the case.

6. The system of claim 5, wherein the processing unit is further configured to:
determine if the at least one concerned party accepted, via the at least one client device, the calendar event on a calendar associated with the at least one concerned party; and
provide a subsequent notification to the at least one concerned party regarding the schedule associated with the case.

7. The system of claim 1, wherein the processor is further configured to:
receive an indication of at least one affiliated party that should receive notifications associated with the case; and
wherein the communication module is further configured to:
provide notifications to the at least one affiliated party.

8. The system of claim 1, wherein the database is configured to retrieve updated records associated with the plurality of cases, and wherein the communication module is configured to provide notifications associated with the updated records to the at least one concerned party.

9. The system of claim 1, wherein the at least one concerned party comprises at least one of an attorney, a paralegal, a plaintiff, a defendant and a subscriber.

10. The system of claim 9, wherein the processor is further configured to generate a Graphical User Interface (GUI) configured to enable a user to designate the at least one concerned party.

11. The system of claim 1, wherein the communication module is further configured to receive at least one of an acceptance and a rejection associated with the notification from the at least one electronic device.

12. The system of claim 11, wherein a calendar on the at least one electronic device is updated with the schedule based on the acceptance.

13. The system of claim 1, wherein the communication module is further configured to generate a reminder notification based on failure of the at least one concerned party to send at least one of the acceptance and the rejection within a predetermined time period.

14. The system of claim 1, wherein the communication module is further configured to communicate with a data source, wherein the records of the plurality of cases are based on the communication with the data source.

15. The system of claim 14, wherein the communication with the data source is based on an Application Programming Interface (API).

16. The system of claim 14, wherein the communication with the data source comprises web scraping.

17. The system of claim 1, wherein the processor is configured to map a plurality of fields in the data source with a corresponding plurality of fields in the database.

18. The system of claim 1, wherein the processor is configured to detect an event corresponding to the case, wherein the notification comprises case data associated with the event.

19. The system of claim 18, wherein detection of the event comprises monitoring for a change in a data source associated with the legal institution, wherein the communication module is further configured to communicate with the data source.

20. The system of claim 1, wherein the processor is configured to generate the notification prior to the date and the time by a predetermined time duration.
